(19) United States
(12) Patent Application Publication
(10) Pub. No.: US 2025/0108412 A1
(43) Pub. Date: Apr. 3, 2025

(54) IMAGE READING DEVICE

(71) Applicant: SEIKO EPSON CORPORATION, Tokyo (JP)

(72) Inventors: Yudai TARUYA, KITAKYUSHU-SHI (JP); Masaki NAMIKI, KITAKYUSHU-SHI (JP)

(21) Appl. No.: 18/903,897

(22) Filed: Oct. 1, 2024

(30) Foreign Application Priority Data
Oct. 2, 2023 (JP) 2023-171436

(51) Int. Cl. B08B 5/02; B08B 5/04

(52) U.S. Cl. CPC B08B 5/026; B08B 5/046

(57) ABSTRACT

An image reading device includes a reading unit configured to read an image of a medium conveyed in a conveyance direction through a conveyance path, and a cleaning unit configured to clean a cleaning object in the conveyance path with an airflow. The cleaning unit includes a foreign matter moving unit configured to cause an airflow to flow in the conveyance path in a direction from one end to the other end that intersects the conveyance direction to move a foreign matter located at the cleaning object from the one end to the other end, and a first storage unit located at the other end of the conveyance path and configured to receive and store the foreign matter moved by the airflow in the direction from the one end to the other end.

The present application is based on, and claims priority from JP Application Serial Number 2023-171436, filed Oct. 2, 2023, the disclosure of which is hereby incorporated by reference herein in its entirety.

### BACKGROUND

### 1. Technical Field

The present disclosure relates to an image reading device.

### 2. Related Art

Examples of a device of this type include the device disclosed in JP-A-2008-297023. JP-A-2008-297023 discloses an image reading device including an image reading means, and an airflow generation means that generates an airflow from a position upstream of the image reading means in the conveyance path. A foreign matter chamber that stores foreign matters is disposed on the downstream side of the image reading means.

In the device disclosed in JP-A-2008-297023, the airflow generated from the airflow generation means flows from the upstream side toward the downstream side in the conveyance path, and as such the foreign matters scatter to the downstream side in the conveyance path.

### SUMMARY

To solve the above-mentioned problems, an image reading device according to the present disclosure includes a reading unit configured to read an image of a medium conveyed in a conveyance direction through a conveyance path, and a cleaning unit configured to clean a cleaning object in the conveyance path with an airflow. The cleaning unit includes a foreign matter moving unit configured to cause an airflow to flow in the conveyance path in a direction from one end to the other end that intersects the conveyance direction to move a foreign matter located at the cleaning object from the one end to the other end, and a first storage unit located at the other end of the conveyance path and configured to receive and store the foreign matter moved by the airflow in the direction from the one end to the other end.

### BRIEF DESCRIPTION OF THE DRAWINGS

FIG. 1 is a perspective view of an external appearance of an image reading device according to an embodiment 1.

FIG. 2 is a perspective view of a cleaning unit of the same embodiment.

FIG. 3 is a perspective view of a main part illustrating a part of a cross section of the cleaning unit of the same embodiment.

FIG. 4 is a side sectional view and a partially enlarged view of the cleaning unit of the same embodiment.

FIG. 5 is a perspective view of a cleaning unit of an embodiment 2.

FIG. 6A is a side sectional view of the cleaning unit of the embodiment 2.

FIG. 6B is a side sectional view of the cleaning unit of the embodiment 2.

FIG. 7 is a side sectional view of a modification of the cleaning unit of the embodiment 2.

FIG. 8 is a side sectional view of a cleaning unit of an embodiment 4.

FIG. 9 is a side sectional view of a cleaning unit of an embodiment 5.

FIG. 10A is a side sectional view of a main part of an embodiment 3.

FIG. 10B is a side sectional view of a main part of the embodiment 3.

FIG. 11A is a side sectional view of a cleaning unit of an embodiment 6.

FIG. 11B is a side sectional view of the cleaning unit of the embodiment 6.

FIG. 12A is a side view illustrating a structure that enables the replacement of a second cleaning member.

FIG. 12B is a side view illustrating the structure that enables the replacement of the second cleaning member.

FIG. 13A is a perspective view of a main part illustrating the structure that enables the replacement of the second cleaning member.

FIG. 13B is a perspective view of a main part illustrating the structure that enables the replacement of the second cleaning member.

### DESCRIPTION OF EMBODIMENTS

The present disclosure is briefly described below.

An image reading device according to a first aspect of the present disclosure includes a reading unit configured to read an image of a medium conveyed in a conveyance direction through a conveyance path, and a cleaning unit configured to clean a cleaning object in the conveyance path with an airflow. The cleaning unit includes a foreign matter moving unit configured to cause an airflow to flow in the conveyance path in a direction from one end to the other end that intersects the conveyance direction to move a foreign matter located at the cleaning object from the one end to the other end, and a first storage unit located at the other end of the conveyance path and configured to receive and store the foreign matter moved by the airflow in the direction from the one end to the other end.

The “cleaning object of conveyance path” as used herein means that the cleaning object is not only the path component itself making up the conveyance path for conveying the medium, but also other members at positions facing the medium. In other words, the term means that the cleaning object includes other members such as a roller that applies a conveyance force to the medium and the reading unit disposed along the conveyance path and the like.

According to the present aspect, the cleaning unit includes the foreign matter moving unit and the first storage unit, and the foreign matter moving unit moves to the first storage unit the foreign matter adhered on the cleaning object by causing airflow to flow in the direction from one end to the other end that is the direction intersecting the conveyance direction. Thus, the scattering of the foreign matter to the conveyance direction of the conveyance path can be suppressed, and the foreign matter can be efficiently collected.

In image reading device of a second aspect of the present disclosure according to the first aspect, the foreign matter moving unit includes an airflow generation unit, and an airflow direction restriction unit configured to set a flow direction of airflow supplied from the airflow generation unit to the direction from the one end to the other end.

The present aspect includes the airflow direction restriction unit that sets to the direction from the one end to the other end the flow direction of the airflow supplied from the airflow generation unit. In this manner, the airflow direction restriction unit restricts the airflow direction to the direction from the one end to the other end, and thus the foreign matter can be efficiently moved toward the first storage unit.

In image reading device of a third aspect of the present disclosure according to the first aspect, the first storage unit includes a collection unit configured to allow the airflow to pass through, and capture the foreign matter.

According to the present aspect, the first storage unit includes the collection unit that allows the airflow to pass through and captures the foreign matter, and thus the foreign matter can be efficiently collected without disturbing the airflow in the direction from the one end to the other end.

In image reading device of a fourth aspect of the present disclosure according to the second aspect, the airflow direction restriction unit includes a cylindrical part that is long in the direction from the one end to the other end, and a plurality of blowout holes provided parallel to each other in the direction from the one end to the other end at portions in the cylindrical part facing the conveyance path, and a blow out direction of the airflow of the blowout hole is tilted toward the other end.

According to the present aspect, the plurality of the blowout holes provided parallel to the direction from the one end to the other end at the cylindrical part is provided such that the blow out direction of the airflow is tilted toward the other end. Specifically, the airflow is blown out from the plurality of the blowout holes from the one end side toward the other end side. In this manner, the foreign matter is guided from the one end side to the other end side, and the foreign matter can be efficiently collected.

In image reading device of a fifth aspect of the present disclosure according to the fourth aspect, the cylindrical part is rotatable around a shaft extending in the direction from the one end to the other end, the cylindrical part includes a first cleaning member configured to rub and clean the cleaning object, the image reading device includes a second storage unit configured to receive a foreign matter on the cleaning object that is cleaned by the first cleaning member through a rotation of the cylindrical part, and the foreign matter stored in the second storage unit is moved by the airflow to the first storage unit.

In image reading device of a sixth aspect of the present disclosure according to the fifth aspect, the second storage unit includes a second cleaning member, and the second cleaning member cleans the foreign matter adhered on the first cleaning member by making contact with the first cleaning member that is being rotated, and stores the foreign matter in the second storage unit.

According to the present aspect, the second cleaning member cleans the foreign matter adhered on the first cleaning member by making contact with the rotating first cleaning member, and stores it in the second storage unit. In this manner, the foreign matter can be efficiently collected without reducing the cleaning performance of the first cleaning member.

In image reading device of a seventh aspect of the present disclosure according to the fifth aspect, the second storage unit is configured to approach and move away from the cleaning object, and cleaning is performed by the first cleaning member with the second storage unit approached the cleaning object.

According to the present aspect, the second storage unit can approach and move away from the cleaning object, and thus the first cleaning member performs the cleaning in the approached state. With the second storage unit set close to the cleaning object, the scattering of the airflow in the conveyance direction can be effectively suppressed. In particular the second storage unit in contact with the cleaning object can further effectively suppress the scattering.

In image reading device of an eighth aspect of the present disclosure according to the fourth aspect, the first storage unit and the cylindrical part are integrated with each other and are movable along the conveyance path.

According to the present aspect, the first storage unit and the cylindrical part are integrated with each other and are movable along the conveyance path, and thus the cleaning can be easily performed over a wide range in the conveyance direction of the conveyance path.

### Embodiment

An embodiment of an image reading device according to the present disclosure is described below with reference to the drawings.

In the following description, three axes that are orthogonal to each other are referred to as an X axis, a Y axis, and a Z axis as illustrated in each of the drawings. Directions indicated by arrows of the three axes (X, Y, and Z) are +directions of the respective directions, and the opposite directions are-directions. The Z axis direction corresponds to a vertical direction, i.e., a direction in which gravity acts, with the +Z direction indicating a vertically upward direction and the −Z direction indicating a vertically downward direction. The X axis direction and the Y axis direction correspond to horizontal directions. The +Y direction indicates a forward direction of the device, and the −Y direction indicates a rearward direction of the device. The +X direction indicates a rightward direction of the device, and the −X direction indicates a leftward direction of the device.

### Overall Schematic Structure of Image Reading Device

The image reading device of this embodiment is a scanner that can read the image of a medium serving as a document. Here, the image means an image that is visually recorded on the medium, and is, for example, a character, a figure, a table, a picture, a photograph, or the like. In addition, the medium is not limited to a sheet, and also includes a card, a booklet, and the like. An image reading device 1 is not limited to a scanner, but may also be a copier, facsimile machine, or the like.

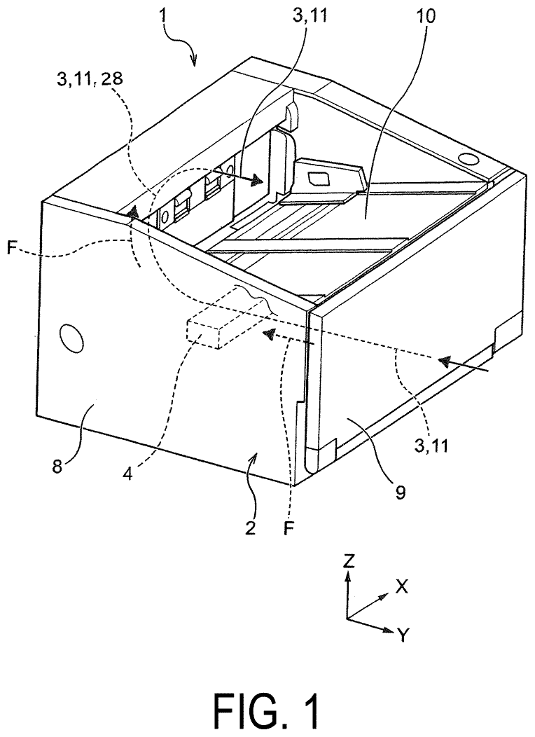

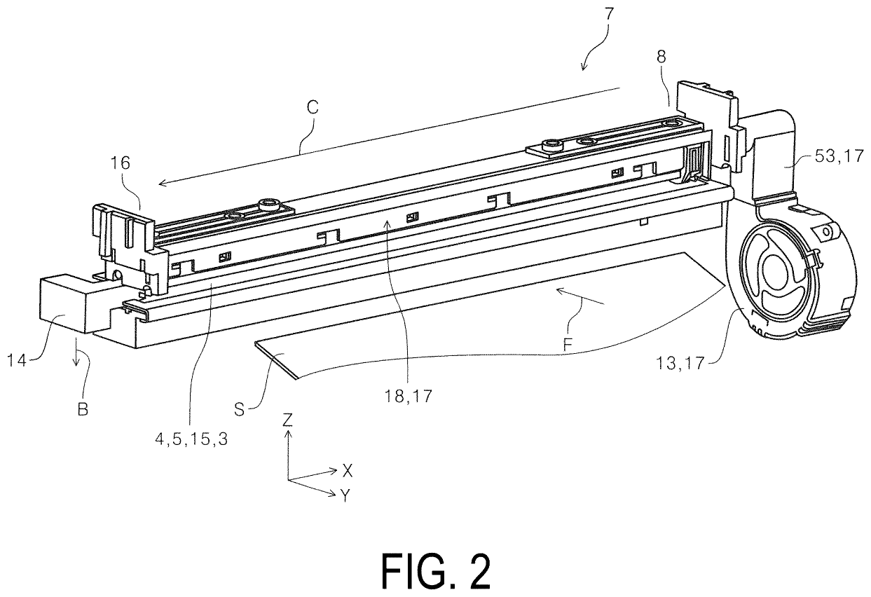

As illustrated in FIG. 1 and FIG. 2, the image reading device 1 of this embodiment includes inside a device body 2, a medium conveyance device 11 and a reading unit 4.

The medium conveyance device 11 includes a conveyance path 3 for conveying in a conveyance direction F a medium S (FIG. 2) such as a sheet. A plurality of conveyance rollers omitted in the illustration is disposed along the conveyance direction F in the conveyance path 3. The conveyance roller rotates around the shaft to apply to the medium S a conveyance force in the conveyance direction F.

The reading unit 4 is disposed along the conveyance path 3. The reading unit 4 optically reads the image of the medium S conveyed through the conveyance path 3 to acquire image information. In this embodiment, the conveyance path 3 includes a reversing unit 28.

The front surface of the image reading device 1 makes up a medium placing part 9 for placing the medium. The medium placing part 9 is set to an open state that enables the medium S to be placed when the upper end portion is opened to the near side (+Y direction) with the lower end portion as a turning fulcrum and set to the horizontal state. FIG. 1 illustrates the medium placing part 9 in a closed state.

The medium S placed on the medium placing part 9 in the open state is picked up one by one by a picking roller omitted in the illustration, conveyed in the conveyance direction F through the conveyance path 3, subjected to reading at the reading unit 4, and conveyed through a reversing unit 5 so as to be ejected to an ejection reception unit 10 located at an upper portion of the device body 2.

### Embodiment 1

The image reading device 1 of the embodiment 1 is described below based on FIG. 2 to FIG. 4.

The image reading device 1 of the embodiment 1 includes the reading unit 4 that reads the image of medium S conveyed in the conveyance direction F through the conveyance path 3, and a cleaning unit 7 that cleans a cleaning object 5 in the conveyance path 3 with an airflow B.

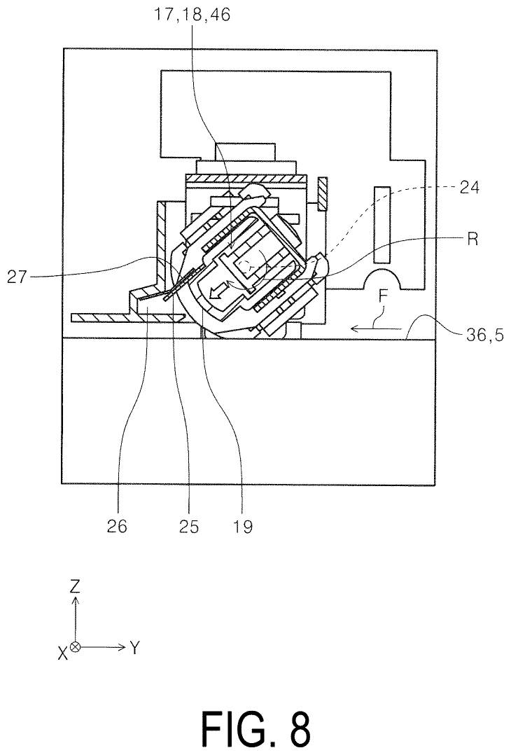

The term “the cleaning object 5 in the conveyance path 3” as used herein means that the cleaning object 5 is not only a conveyance path component 36 (described later FIG. 8) itself making up the conveyance path 3 for conveying the medium S, but also other members located at positions facing the medium S. In other words, this means that the cleaning object 5 includes other members such as a roller that applies a conveyance force to the medium S and the reading unit 4 disposed along the conveyance path 3.

The reading unit 4 includes an optically transparent member 15 such as glass. In this embodiment, the optically transparent member 15 of the reading unit 4 is the cleaning object 5 of the cleaning unit 7.

### Cleaning Unit

The cleaning unit 7 includes a foreign matter moving unit 17 and a first storage unit 14.

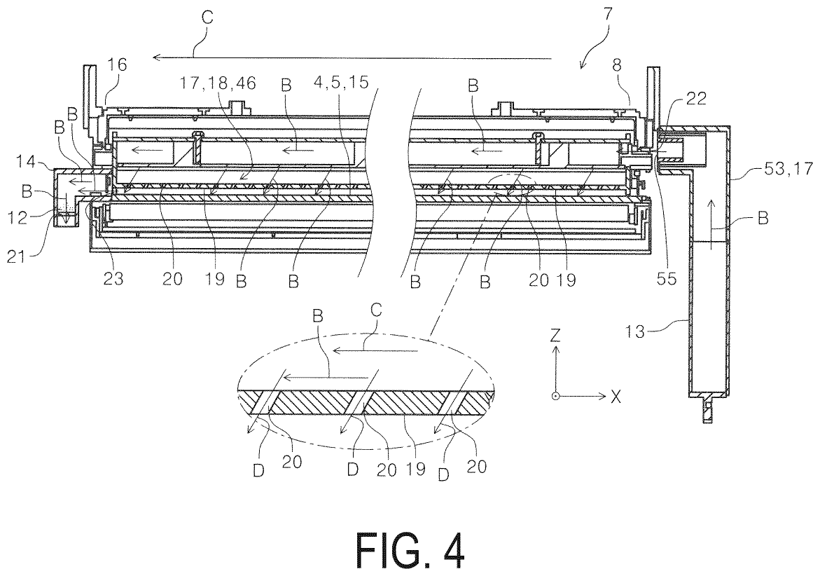

As illustrated in FIG. 4, the foreign matter moving unit 17 is configured to cause the airflow B in the conveyance path 3 to flow in a direction C from one end 8 toward the other end 16 in the direction intersecting the conveyance direction F so as to move a foreign matter 12 adhered on the cleaning object 5 from the one end 8 to the other end 16. Note that the illustration of the foreign matter 12 adhered on the cleaning object 5 is omitted, and only the foreign matter 12 stored in the first storage unit is illustrated.

The first storage unit 14 is located at the other end 16 of the conveyance path 3, and configured to receive and store the foreign matter 12 moved by the airflow B in the direction C.

### Foreign Matter Moving Unit

As illustrated in FIG. 2 and FIG. 4, in this embodiment, the foreign matter moving unit 17 includes an airflow generation unit 13 and an airflow direction restriction unit 18.

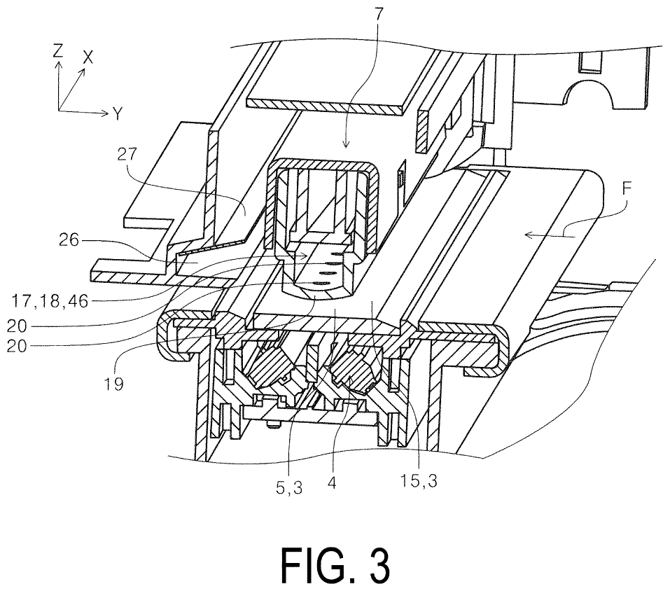

In this embodiment, the airflow direction restriction unit 18 includes a cylindrical part 46 that is long in the direction C from one end 8 toward the other end 16, and a plurality of blowout holes 20, 20, . . . at a portion 19 of the cylindrical part 46 that faces the conveyance path 3. As illustrated in FIG. 3 and FIG. 4, the plurality of blowout holes 20, 20, . . . is disposed in one line in parallel to the direction C from one end 8 toward the other end 16. Note that they may be disposed in two or more lines.

As illustrated in the partially enlarged view of FIG. 4, the blowout holes 20, 20, . . . are formed such that a blow out direction D of the airflow B is tilted toward the other end 16.

Here, the airflow generation unit 13 is a blower. The airflow generation unit 13 and the cylindrical part 46 of the airflow direction restriction unit 18 are coupled with each other through a duct 53. The airflow generated at the airflow generation unit 13 is jetted from an airflow outlet 55 of the duct 53 to an airflow inlet 22 of the cylindrical part 46 so as to flow into the cylindrical part 46. As illustrated in FIG. 4, the airflow B having entered the cylindrical part 46 flow in the direction C inside the cylindrical part 46, and is jetted from the blowout holes 20, 20, . . . in a direction not orthogonal, but tilted, i.e., oblique, to the cleaning object 5. With the airflow B jetted obliquely to the cleaning object 5, the foreign matter 12 adhered on the cleaning object 5 can be carried, i.e., moved, in the direction C.

### First Storage Unit

As illustrated in FIG. 4, in this embodiment, the first storage unit 14 includes a collection unit 21 that allows the airflow B to pass through and captures the foreign matter 12. The collection unit 21 is a filter that blocks the foreign matter 12. The direction in which the airflow B passes and goes out of the first storage unit 14 is not limited to the structure of the downward direction illustrated in FIG. 4. A structure of the upward direction or a structure of the lateral direction may also be adopted.

The first storage unit 14 includes an airflow inlet 23. The airflow inlet 23 is spatially coupled with the region between the cleaning object 5 and the portion 19 where the blowout holes 20, 20, . . . of the cylindrical part 46 are provided. The first storage unit 14 can receive inside the foreign matter 12 moved in the direction C from the airflow inlet 23 with the airflow B of the foreign matter moving unit 17.

The overall operation of the image reading device 1, including the cleaning operation of the cleaning unit 7 for the cleaning object 5, is performed by a control unit that is omitted in the illustration.

The control unit includes a CPU, a flash ROM, and a RAM. The CPU performs various arithmetic processes in accordance with a program stored in the flash ROM, and controls the operation of the entire the image reading device 1. The flash ROM serving as an example of a storage unit is a readable and rewritable nonvolatile memory. The RAM serving as an example of a storage unit temporarily stores a variety of information.

### Effects of First Embodiment

(1) In the image reading device 1 of this embodiment, the cleaning unit 7 includes the foreign matter moving unit 17 and the first storage unit 14, and the foreign matter moving unit 17 causes the airflow B to flow in the direction C from one end 8 toward the other end 16 in the direction intersecting the conveyance direction F so as to move the foreign matter 12 adhered on the cleaning object 5 to the first storage unit 14. In this manner, the scattering of the foreign matter 12 in the conveyance direction F of the conveyance path 3 can be suppressed, and the foreign matter 12 can be efficiently collected.
(2) In addition, this embodiment includes the airflow direction restriction unit 18 that sets the flow direction of the airflow B supplied from the airflow generation unit 13 to the direction C from one end 8 toward the other end 16. In this manner, the airflow direction restriction unit 18 restricts the direction of the airflow B to the direction C from one end 8 toward the other end 16, and thus the foreign matter 12 can be efficiently moved toward the first storage unit 14.
(3) In addition, in this embodiment, the first storage unit 14 includes the collection unit 21 that allows the airflow B to pass through and captures the foreign matter 12, and thus the foreign matter 12 can be efficiently collected without disturbing the flow of the airflow B in the direction C from one end 8 toward the other end 16.
(4) In addition, in this embodiment, the plurality of blowout holes 20, 20, . . . provided at the cylindrical part 46 in parallel to the direction C from one end 8 toward the other end 16 is provided such that the blow out direction D of the airflow B is tilted toward the other end 16. Specifically, from the plurality of blowout holes 20, 20, . . . the airflow B is blown out from the one end 8 side toward the other end 16 side. In this manner, the foreign matter 12 is guided from the one end 8 side toward the other end 16 side, and the foreign matter 12 can be efficiently collected inside the first storage unit 14.

### Embodiment 2

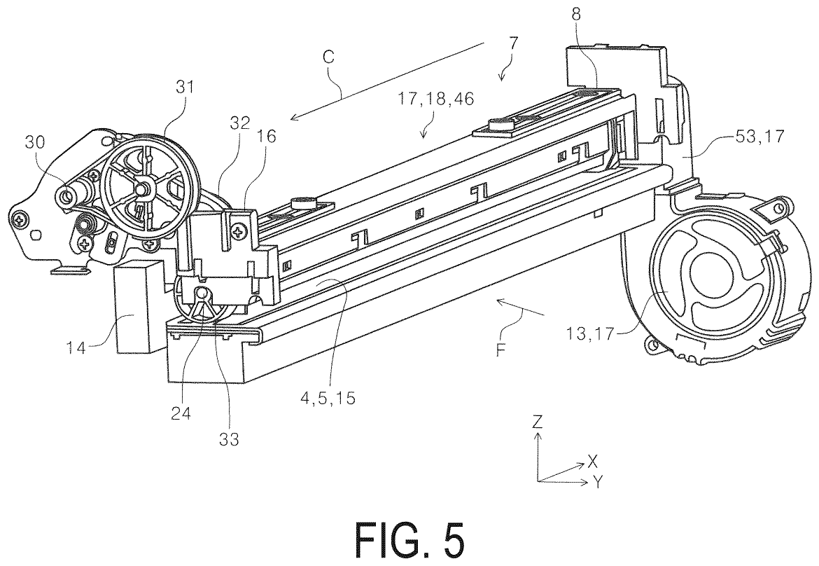

Next, the image reading device 1 according to an embodiment 2 is described with respect to FIG. 5 to FIG. 7. The same parts as those of the embodiment 1 are denoted with the same reference numerals, and description of their configuration and corresponding effects will be omitted.

As illustrated in FIG. 5, in this embodiment, the cylindrical part 46 is configured to be rotatable around a shaft 24 extending in the direction C from one end 8 toward the other end 16. The rotation of the cylindrical part 46 is achieved when the rotation of a motor 30 is transmitted to a first gear 31, a second gear 32, and a third gear 33 in this order. The third gear 33 is fixed to the shaft 24 of the cylindrical part 46 so as to rotate together.

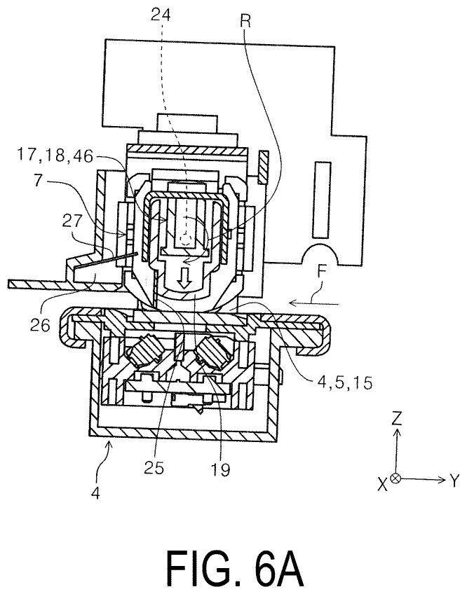

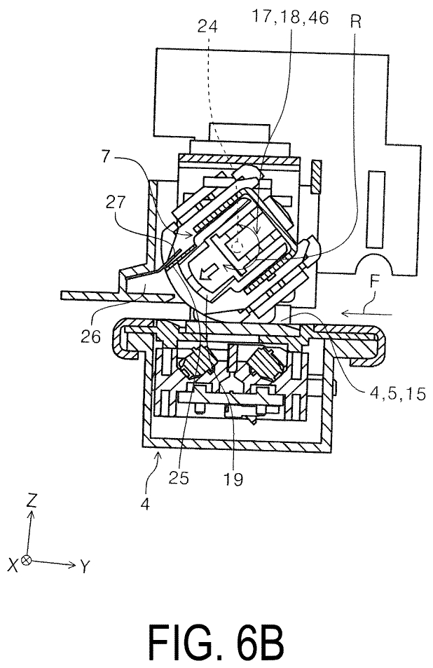

Further, as illustrated in FIGS. 6A and 6B, the cylindrical part 46 includes a first cleaning member 25 that rubs and cleans the cleaning object 5. The first cleaning member 25 is a brush with the base end fixed to one side surface of the cylindrical part 46. The first cleaning member 25 cleans the cleaning object 5 by sweeping and rubbing it by rotating the cylindrical part 46 around the shaft 24 in a clockwise direction R from the state illustrated in FIG. 6A. Note that when the cylindrical part 46 rotates from the state illustrated in FIG. 6A, the cleaning object 5 is cleaned in a sweeping manner with the cylindrical part 46 rotated one rotation or more.

In addition, a second storage unit 26 is provided that receives the foreign matter 12 on the cleaning object 5 cleaned by the first cleaning member 25 by rotating the cylindrical part 46 in the direction R around the shaft 24. The second storage unit 26 with substantially the same length as the total length of the cylindrical part 46 is disposed along the cylindrical part 46. The side of the second storage unit 26 opposite to the cylindrical part 46 is configured to be open over the total length of the cylindrical part 46 so as to be able to receive inside the foreign matter 12 cleaned by the first cleaning member 25.

The foreign matter 12 stored in the second storage unit 26 is moved to the first storage unit 14 with the airflow B. As illustrated in FIG. 5, the first storage unit 14 is shifted to the −Y direction in comparison with the structure of the embodiment 1 while avoiding the position of the third gear 33. The airflow inlet 23 of the first storage unit 14 is configured to be able to receive the airflow B containing the foreign matter 12 jetted from the blowout holes 20, 20, . . . of the cylindrical part 46 toward the cleaning object 5 so as to flow in the direction C.

Further, the first storage unit 14 is configured to be able to receive the airflow B flowing in the direction C inside the second storage unit 26. Specifically, in this embodiment, the first storage unit 14 is configured to receive the airflow B flowing in the direction C inside the second storage unit 26 with the cylindrical part 46 in the state illustrated in FIG. 6B in addition to the airflow B flowing in the direction C on the cleaning object 5 with the cylindrical part 46 in the state illustrated in FIG. 6A.

In addition, as illustrated in FIG. 5, in this embodiment, the second storage unit 26 includes the second cleaning member 27. The second cleaning member 27 is a brush with the base end fixed to the second storage unit 26.

When the cylindrical part 46 rotates in the direction R, the second cleaning member 27 is set to the state illustrated in FIG. 6B and brought into contact with the first cleaning member 25. When the cylindrical part 46 further rotates in the direction R, the foreign matter 12 adhered on the first cleaning member 25 is cleaned by being rubbed against the second cleaning member 27, and stored inside the second storage unit 26.

### Effects of Embodiment 2

(1) This embodiment includes the second storage unit 26 that receives the foreign matter 12 on the cleaning object 5 cleaned by the first cleaning member 25 by rotating the cylindrical part 46, and the foreign matter 12 stored in the second storage unit 26 is moved to the first storage unit 14 with the airflow B. In this manner, the foreign matter 12 can be stored in the first storage unit 14 and the second storage unit 26, and the foreign matter 12 can be efficiently collected while suppressing the scattering of the foreign matter 12 in the conveyance direction F.
(2) In addition, in this embodiment, the second cleaning member 27 cleans the foreign matter 12 adhered on the first cleaning member 25 by making contact with the rotating first cleaning member 25, and stores it in the second storage unit 26. In this manner, the foreign matter 12 can be efficiently collected without reducing the cleaning performance of the first cleaning member 25.

### Modification 1 of Embodiment 2

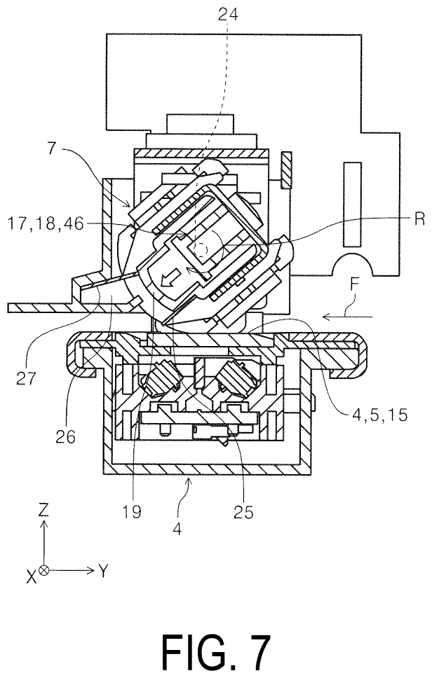

FIG. 7 illustrates a modification of the embodiment 2. This modification differs only in that the first cleaning member 25 is fixed to the other side surface, not the one side surface of the cylindrical part 46. The cleaning operation of the first cleaning member 25 and the corresponding effects are basically the same, and therefore the description thereof will be omitted.

### Embodiment 3

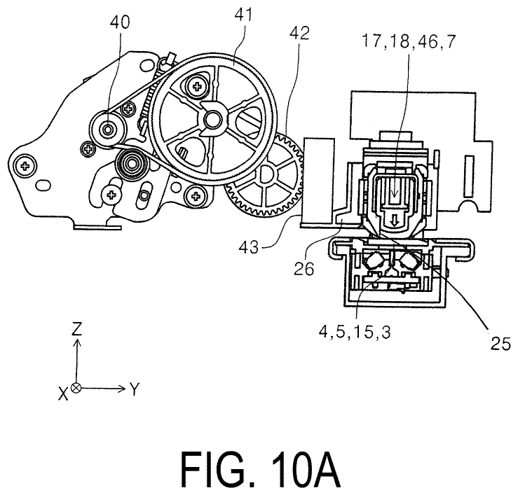

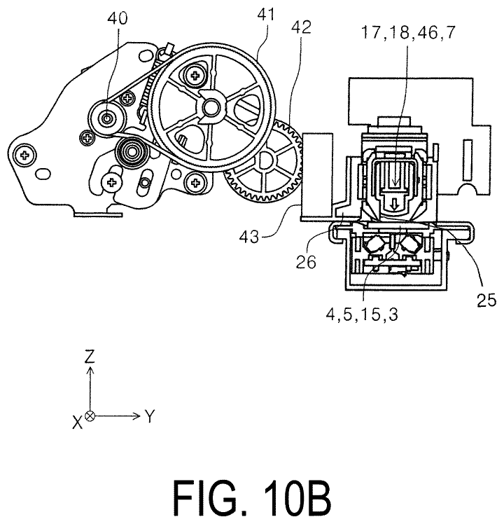

Next, the image reading device 1 according to the embodiment 3 is described with reference to FIG. 10. The same parts as those of the embodiment 1 and the embodiment 2 are denoted with the same reference numerals, and description of their configuration and corresponding effects will be omitted. Note that in FIG. 10, the structures of the cylindrical part 46 and the reading unit 4 are the same as those of FIGS. 6A and 6B, and as such the illustration is simplified by omitting the hatching of a part or a cross section of the components.

As illustrated in FIG. 10, in this embodiment, the second storage unit 26 is configured to be able to approach and move away from the cleaning object 5. The second storage unit 26 includes a rack 43. The approach and separation of second storage unit 26 from the cleaning object 5 are achieved by a rack pinion mechanism of a pinion 42 and the rack 43 when the rotation of a motor 40 is transmitted from a first gear 41 to a second gear 42 serving as the pinion 42 (for which the same reference numeral is used).

In this embodiment, the cleaning is performed by the first cleaning member 25 with the second storage unit 26 approached the cleaning object 5.

In this embodiment, the second storage unit 26 can approach and move away from the cleaning object 5, and the cleaning is performed by the first cleaning member 25 in the approached state. When the second storage unit 26 is set close to the cleaning object 5, the scattering of the airflow B in the conveyance direction F can be effectively suppressed. In particular the second storage unit 26 in contact with the cleaning object 5 can further effectively suppress the scattering.

### Embodiment 4

Next, the image reading device 1 according to an embodiment 4 is described with reference to FIG. 8. The same parts as those of the embodiment 1 and the embodiment 2 are denoted with the same reference numerals, and description of their configuration and corresponding effects will be omitted.

As illustrated in FIG. 8, in this embodiment, the cleaning object 5 is the conveyance path component 36 making up the conveyance path 3. FIG. 8 corresponds to a state where the cylindrical part 46 is rotated to set the state illustrated in FIG. 6B after the cleaning using the airflow B is performed on a part of the conveyance path component 36 that is set as the cleaning object 5 with the cylindrical part 46 of the state illustrated in FIG. 6A.

As in the embodiment 1 and the embodiment 2, the cleaning for removing the foreign matter 12 can be performed with the conveyance path component 36 set as the cleaning object 5.

### Embodiment 5

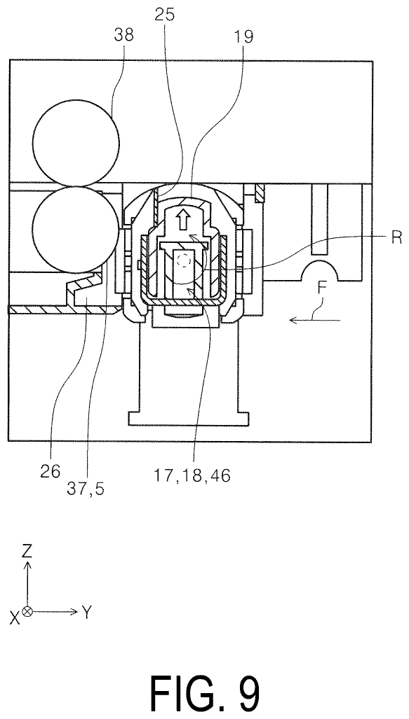

Next, the image reading device 1 according to the embodiment 5 is described with reference to FIG. 9. The same parts as those of the embodiment 1, the embodiment 2, and the embodiment 4 are denoted with the same reference numerals, and description of their configuration and corresponding effects will be omitted.

As illustrated in FIG. 9, in this embodiment, the cleaning object 5 is set as a conveyance driving roller 37 making up the conveyance path 3. The reference numeral 38 represents a driven roller. In this embodiment, the conveyance driving roller 37 is set to a rotating state, and this rotating conveyance driving roller 37 is set as a cleaning object. FIG. 9 corresponds to a state before the conveyance driving roller 37 is rubbed and cleaned with the first cleaning member 25 by rotating the cylindrical part 46 in the direction R, in this case the counterclockwise direction, after performing the cleaning with the airflow B flowing in the direction C through the rotating conveyance driving roller 37. By further rotating the cylindrical part 46 counterclockwise in this state, the conveyance driving roller 37 can be rubbed and cleaned with the first cleaning member 25. The foreign matter 12 resulting from the cleaning is stored in second storage unit 2.

As in the embodiment 1 and the embodiment 2, the cleaning for removing the foreign matter 12 can be performed with the conveyance driving roller 37 set as the cleaning object 5.

### Embodiment 6

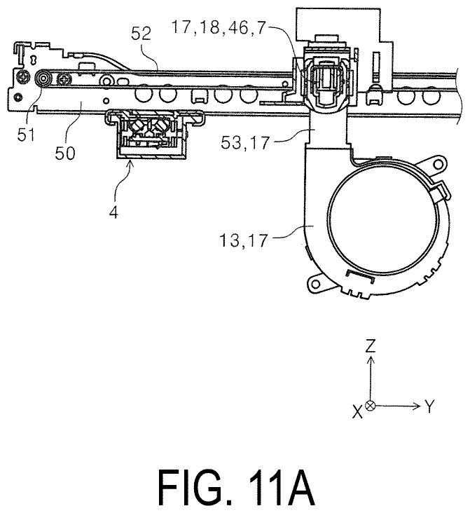

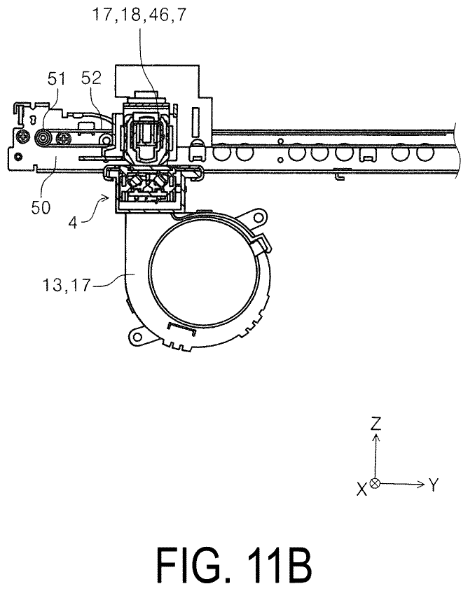

Next, the image reading device 1 according to an embodiment 6 is described with reference to FIG. 11. The same parts as those of the embodiment 1 and the embodiment 2 are denoted with the same reference numerals, and description of their configuration and corresponding effects will be omitted.

As illustrated in FIG. 11, in this embodiment, the first storage unit 14 and the cylindrical part 46 are integrated with each other and are movable along the conveyance path 3. In FIG. 11, the first storage unit 14 is invisible. Here, the airflow generation unit 13 and the duct 53 are also integrated with each other. The configuration in which the first storage unit 14, the cylindrical part 46 and the like are integrated with each other and are movable along the conveyance path 3 is achieved with a motor 51, an endless belt 52 wound around the pinion of the motor 51 to move in a circumferential direction, and a frame 50 to which the motor 51 is fixed and which holds the first storage unit 14, the cylindrical part 46 and the like integrated with each other. The first storage unit 14, the cylindrical part 46 and the like integrated with each other are attached to the endless belt 52 and move together with the endless belt 52.

The state of the upper position in FIG. 11 indicates a state where the cylindrical part 46 or the like is separated away from the reading unit 4 with the reading unit 4 set as the cleaning object 5. The state of the lower position in FIG. 11 indicates a state where the cylindrical part 46 or the like is moved to the position for cleaning the reading unit 4. Note that in FIG. 11, the illustration of cleaning objects other than the reading unit 4 is omitted.

In this embodiment, the first storage unit 14 and the cylindrical part 46 are integrated with each other and can move along the conveyance path 3, and thus the cleaning can be easily performed over a wide range in the conveyance direction F of the conveyance path 3.

### Other Structures: Structure That Enables Replacement of Second Cleaning Member

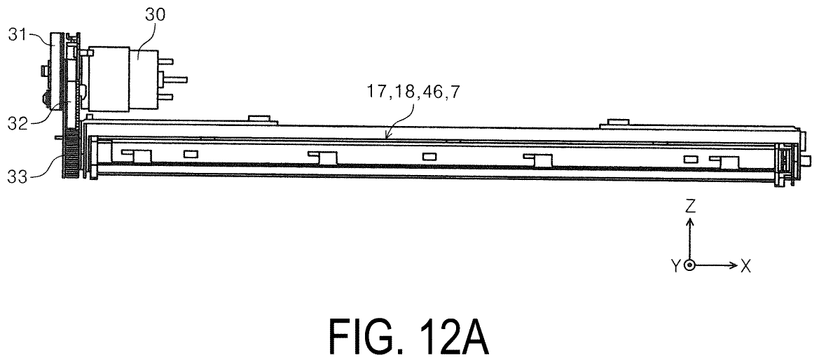

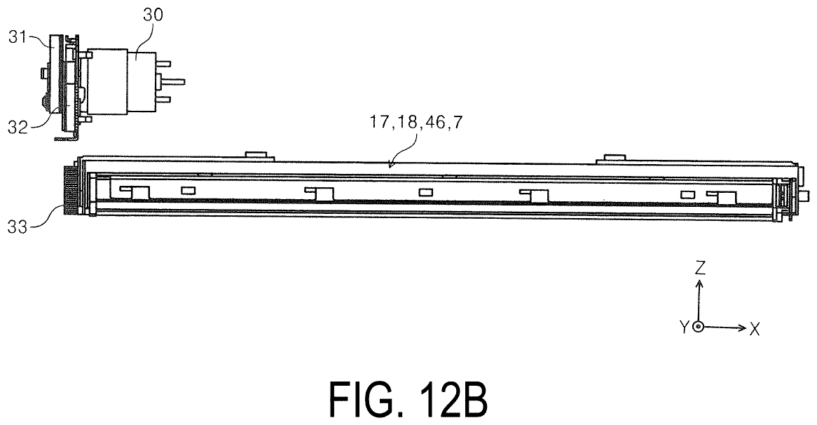

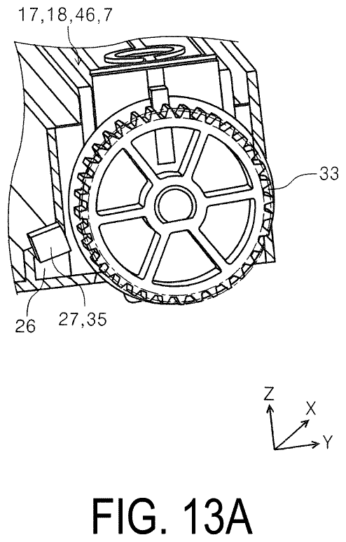

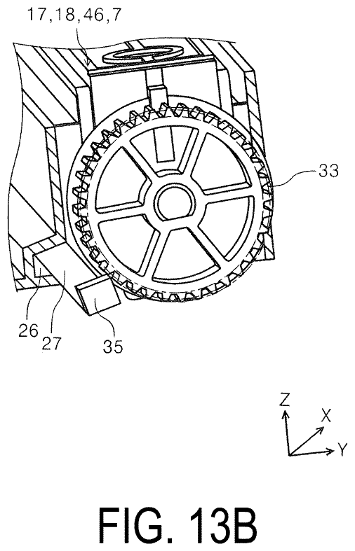

With reference to FIG. 12 and FIG. 13, a structure that enables the replacement of the second cleaning member is described. As illustrated in FIG. 12, the cylindrical part 46 is configured to be slidable in the −Z direction by releasing the connection state of a connecting portion to a peripheral member. By sliding in the −Z direction the cylindrical part 46 in the state of the upper position of FIG. 12, the third gear 33 on the cylindrical part 46 side is separated away from the second gear 32 of the motor 30 side as illustrated in the state of the lower position of FIG. 12.

In the case where the third gear 33 is separated away from the second gear 32, the second cleaning member 27 is accessible as illustrated in the state of the upper position of FIG. 13. The second cleaning member 27 includes a nob 35. As illustrated in the state of the lower position of FIG. 13, by pulling out the second cleaning member 27 from the second storage unit 26 through the nob 35, the second cleaning member 27 can be easily replaced.

Note that the same structure as the structure that enables the replacement of the second cleaning member 27 can be applied also to the first cleaning member 25.

### Other Embodiments

The image reading device 1 according to the present disclosure basically has the above-described configuration of the embodiments, but it is of course possible to change or omit portions of the configuration to the extent that it does not depart from the gist of the present disclosure.

In the above-described embodiment, the foreign matter moving unit 17 includes the airflow generation unit 13 and the airflow direction restriction unit 18. However, the foreign matter 12 may be moved to the first storage unit 14 with a configuration of strongly blowing out the airflow B from the duct 53 in the direction C in the state of making contact with the cleaning object 5, i.e., without providing the airflow direction restriction unit 18. For such a structure, the first storage unit 14 is desirably provided with a suction blower such that a suction force is generated at the airflow inlet 23.

In addition, each embodiment may have a structure in which only the suction blower is provided on the first storage unit 14 side, or a structure in which both the airflow generation unit 13 and the suction blower are provided, instead of the airflow generation unit 13.

What is claimed is:

1. An image reading device comprising:
a reading unit configured to read an image of a medium conveyed in a conveyance direction through a conveyance path; and
a cleaning unit configured to clean a cleaning object in the conveyance path with an airflow, wherein
the cleaning unit includes
a foreign matter moving unit configured to cause an airflow to flow in the conveyance path in a direction from one end to the other end that intersects the conveyance direction to move a foreign matter located at the cleaning object from the one end to the other end, and
a first storage unit located at the other end of the conveyance path and configured to receive and store the foreign matter moved by the airflow in the direction from the one end to the other end.

2. The image reading device according to claim 1, wherein
the foreign matter moving unit includes:
an airflow generation unit, and
an airflow direction restriction unit configured to set a flow direction of airflow supplied from the airflow generation unit to the direction from the one end to the other end.

3. The image reading device according to claim 1, wherein the first storage unit includes a collection unit configured to allow the airflow to pass therethrough, and capture the foreign matter.

4. The image reading device according to claim 2, wherein
the airflow direction restriction unit includes:
a cylindrical part that is long in the direction from the one end to the other end, and
a plurality of blowout holes provided parallel to each other in the direction from the one end to the other end at portions in the cylindrical part facing the conveyance path, and
a blow out direction of the airflow of the blowout hole is tilted toward the other end.

5. The image reading device according to claim 4, wherein
the cylindrical part is rotatable around a shaft extending in the direction from the one end to the other end,
the cylindrical part includes a first cleaning member configured to rub and clean the cleaning object,
the image reading device includes a second storage unit configured to receive a foreign matter on the cleaning object that is cleaned by the first cleaning member through a rotation of the cylindrical part, and
the foreign matter stored in the second storage unit is moved by the airflow to the first storage unit.

6. The image reading device according to claim 5, wherein
the second storage unit includes a second cleaning member, and
the second cleaning member cleans the foreign matter adhered on the first cleaning member by making contact with the first cleaning member that is being rotated, and stores the foreign matter in the second storage unit.

7. The image reading device according to claim 5, wherein
the second storage unit is configured to approach and move away from the cleaning object, and
cleaning is performed by the first cleaning member with the second storage unit approached the cleaning object.

8. The image reading device according to claim 4, wherein the first storage unit and the cylindrical part are integrated with each other and are movable along the conveyance path.
